(19) United States
(12) Patent Application Publication
(10) Pub. No.: US 2006/0026893 A1
(43) Pub. Date: Feb. 9, 2006

(54) Rodent trap

(76) Inventor: Richard B. Sears, San Rafael, CA (US)

Correspondence Address: MICHAEL A. SHIPPEY, PH. D., 4848 LAKEVIEW AVENUE, SUITE B, YORBA LINDA, CA, 92886, US

(21) Appl. No.: 10/910,513

(22) Filed: Aug. 3, 2004

(51) Int. Cl. A01M 23/04

(52) U.S. Cl. 43/69; 43/70

(57) ABSTRACT

Rodent Trap with a lid, a pivot plank, a ferrous metal rectangular open topped box, a magnet, a pivot point, a food holding platform, a guide panel, a climbing ramp or rope and a rodent receptacle. The guide panel and the bait tray are fixed at one end of the rectangular box. The box has half of the floor removed. The pivot point holds the plank so that it can rotate. The pivot plank includes a magnet on its underside. The magnet is attracted to the ferrous metal portion of the floor of the box so that a rodent can climb up the ramp, travel along the pivot plank, wedge itself between the pivot plank and the guide panel in the pursuit of bait causing the magnetic attraction to break and the pivot plank to rotate down causing the rodent to drop into the receptacle below the rectangular box.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of animal traps and more specifically to a rodent trap.

Rodents have long been a problem when they enter spaces where they are not wanted, such as peoples homes, places of business public areas and agricultural areas especially where the use of poisons is problematic.

Over the years many rodent traps have been designed, manufactured and marketed to help catch rats and mice. Some traps attempt to be humane and capture rodents live and unharmed. Other traps are meant to kill the animal.

One rodent trap invented by Paul Benzie, in his patent number 4876821, has designed a trap that includes a magnetically latched trap door so that when the rodent walks down a plank, the weight of the animal causes the magnet to detach and the plank to swing down thereby dropping the rodent into a receptacle below.

Although the Benzie design is efficient in catching rodents, it has certain deficiencies that the present invention attempts to remedy. First, although the Benzie invention claims to be able to reset itself, it appears to be a less than ideal solution because the trap door is pivoted at its far end. Second, the Benzie design relies solely on the weight of the animal to release the trap door. Since the magnet is not moveable, only certain weight animals will cause the door to trigger at the desired time. A light weight rodent may not even trigger the trap door. Other patents that disclose the use of a magnet to help facilitate the capture of rodents are Frank R Stimac's patent number 478766, Daniel B. Meyers patent number 3936972 and Melvin M. Melton's patent number 4578892. All the above patents also fail to provide an ideal rodent catching device that can catch multiple rodents without the need for human resetting, and that can be adjusted to catch rodents of different weights.

### BRIEF SUMMARY OF THE INVENTION

The primary object of the invention is to provide a rodent trap that uses the rodents own muscle power and weight to activate the trap.

Another object of the invention is to provide a rodent trap that can be humane to the rodent.

Another object of the invention is to provide a rodent trap that is benign to the surrounding environment.

Another object of the invention is to provide a rodent trap that can automatically or be, or be adjusted to work for rodents of different sizes and weights

Another object of the invention is to provide a rodent trap that can reset itself without human intervention thereby allowing for the catching of multiple rodents before emptying the trap.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed Rodent Trap comprising: a lid, a pivot plank, a rectangular open topped box having at least a portion constructed of ferrous metal, a magnet, a pivot point, a bait holding platform, a guide panel, a climbing ramp, a rodent catching receptacle, said guide panel and said food tray fixed from side to side across one end of said rectangular box, said rectangular box having approximately half the said food tray end of the floor removed, said pivot point holding said pivot plank located approximately at half the length of said plank so that said plank can rotate about said pivot, said said pivot plank capable of removably receiving at least one magnet on its underside, said magnet capable of magnetically interacting with the floor portion of said rectangular box, so that a rodent can climb up said ramp, travel along said pivot plank, wedge itself between said pivot plank and said guide panel in the pursuit of bait causing the magnetic attraction to break thereby causing said pivot plank to rotate causing said rodent to drop into said receptacle located below said rectangular box.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a perspective view of the invention.

FIG. 2 is an exploded view of the invention.

FIG. 3 is a perspective view of the underside of the lid

FIG. 4 is a side section view of the invention.

FIG. 5 is a side section view with a rodent walking on the pivot plank.

FIG. 6 is a side section view with a rodent falling into the receptacle.

FIG. 7 is a perspective view of an alternate embodiment of the invention

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

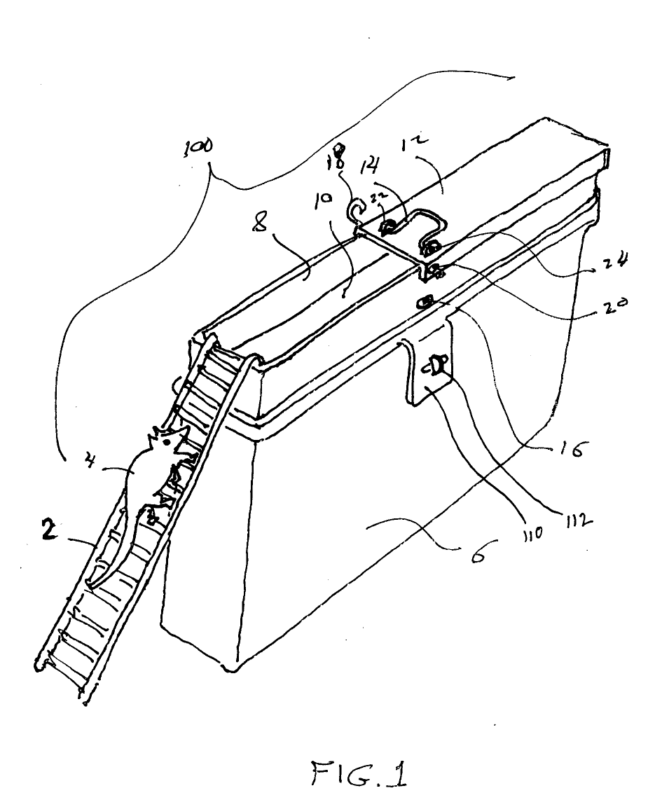

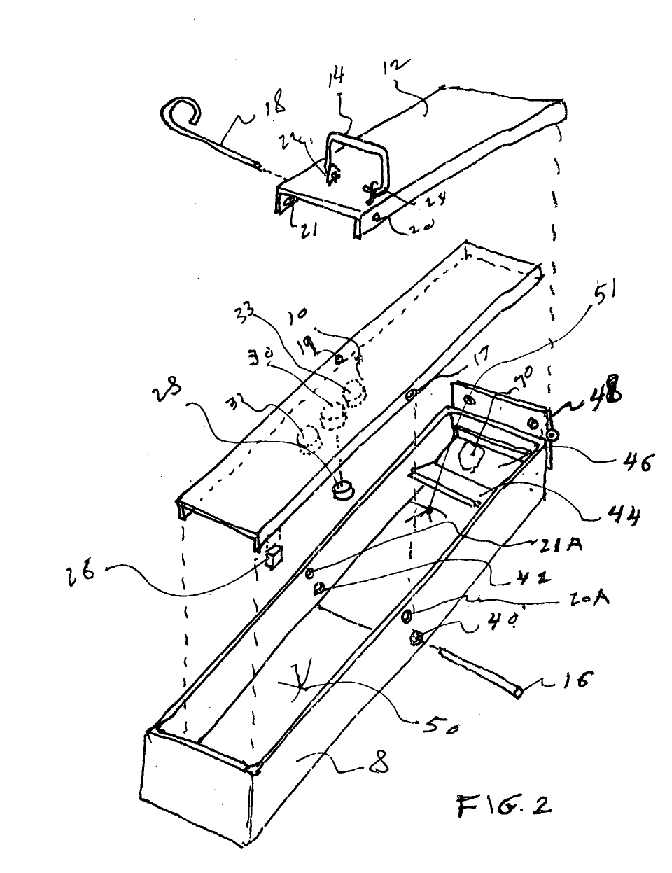

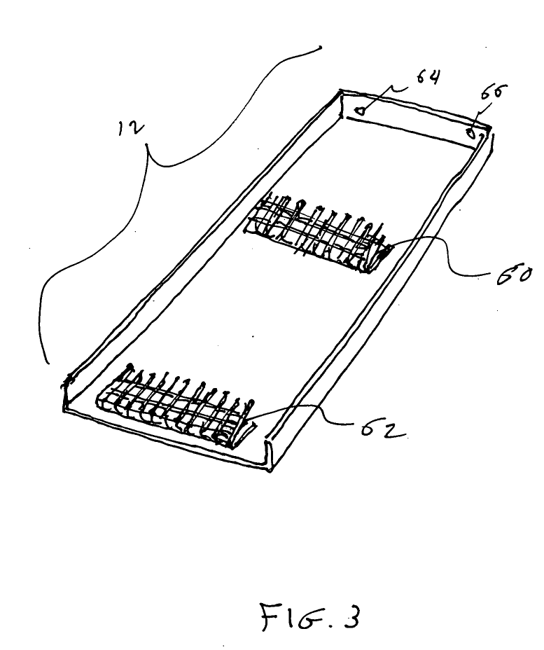

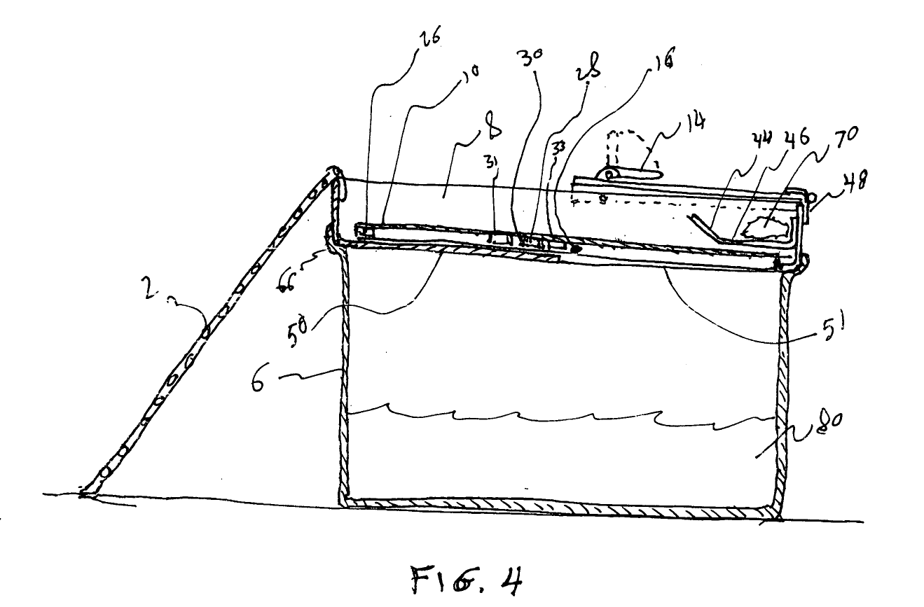

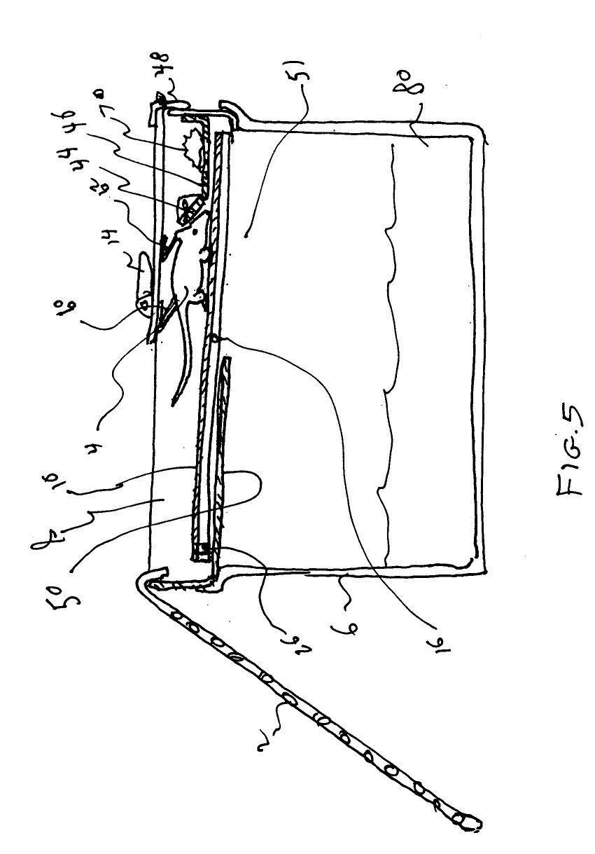

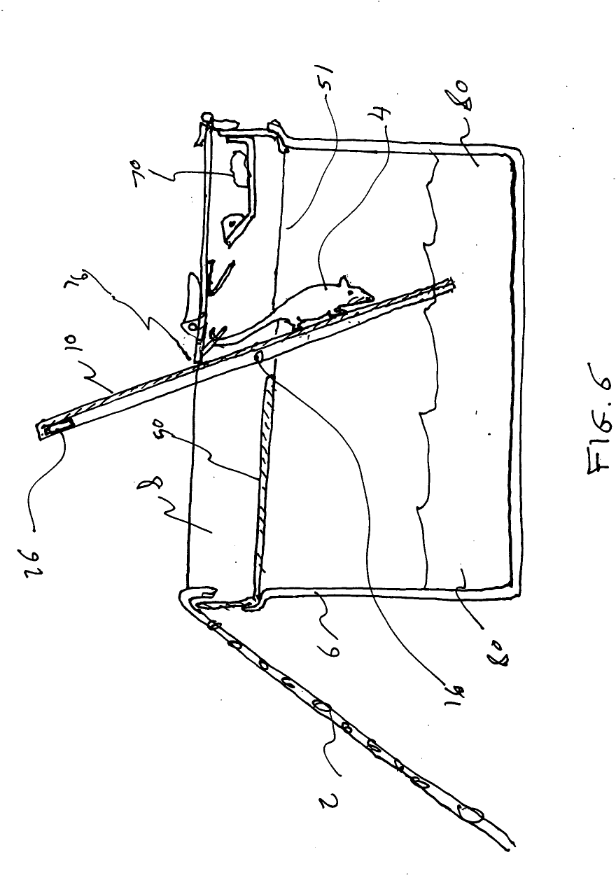

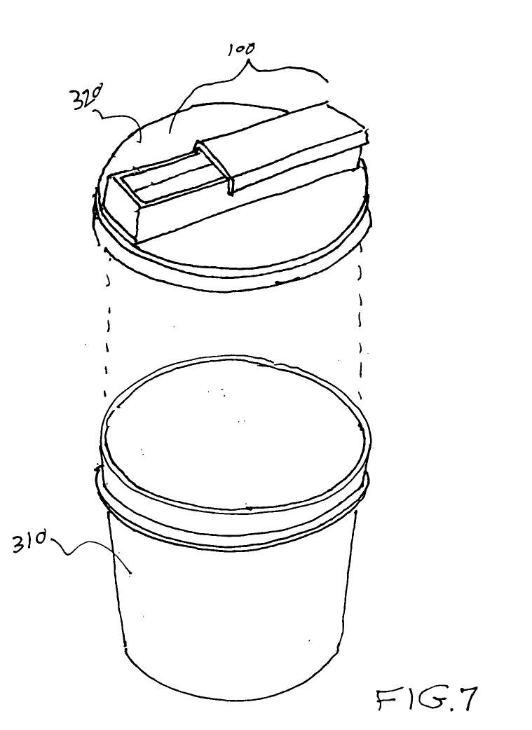

Referring now to FIG. 1 we see a perspective view of the invention 100 where a rodent 4 is climbing up a ladder type ramp 2 to enter an open topped rectangular box 8 and walk along pivot plank 10. It should be noted that other types of standard ramps or ropes can also be used in this invention. A receptacle 6 holds the rectangular box up off the ground. Carry handle 14 located on lid 12 can swivel about pivot points 22, 24. An additional tab 110 and retaining clasp 112 attach the rectangular box to the receptacle allowing the user to lift the entire invention 100 including the receptacle 6. This feature can be particularly helpful if the trap is placed in a recessed location such as below a manhole. A retaining pin 18 is pushed through apertures 20, 21 to keep the lid 12 attached to the rectangular box 8 when a person is carrying the invention 100. Obviously, other standard carrying means may be employed may be used in place of the carry handle shown. FIG. 2 shows an exploded view of the invention 100. In this view it can be seen that pivot plank 10 includes centrally located apertures 17, 19 so that pivot pin 16 to can rotatably engage with pivot plank 10. The far half of the box floor 51 of rectangular box 8 has been removed so that there is room for pivot plank 10 to swing down when a rodent forces it to do so. The pivot point 16 is slightly more than half way from the front surface of the rectangular box 8 so that the weight of the far end of the plank 10 as well as the additional weight of a magnet 26 causes the plank to automatically reset itself after a rodent has forced it down. As the rodent travels down plank 10 in search of food 70, the rodents head and forearms are caused to wedge themselves between a guide plate 44 and the plank 10 as seen more clearly in the side section view of FIG. 5. Referring back to FIG. 2 we see that a magnet 26 can be placed on the underside of plank 10 so that it can magnetically interact with the ferrous metal floor portion 50 of box 8. The strength of the magnet 26 is such that a heavier rodent such as a rat will not dislodge the plank 10 until it is at the far end near the food source 70. If the user of the trap 100 wants to catch a mouse, which is lighter, he or she can use magnet 28 and insert it into receptacle 30. Additional adjustments may be made regarding pivot plank deployment by inserting magnet 28 into a choice of other receptacles 31, 33 which will cause the pivot plank to swing down by responding to a heavier or lighter weight rodent respectively. When the location of magnet 28 is closer to pivot point 16, a lighter weight at the far end of plank 10 will cause magnet 28 to disengage from the ferrous metal portion of box floor 50. FIG. 3 shows the underside of lid 12 where angled and sharp tipped wire panels which act as one way enforcement guides are positioned to cause the rodent to move forward toward the end of plank 10 and not backward. Apertures 64, 66 accept a hinge member 48 that keeps the end of lid 12 in a hinged relationship to the end of box 8. The hinge allows the lid to lift when an extra large rodent attempts to get near the bait 70 in the trap 100. Referring to FIG. 4 we see a side section view of the invention 100. We can see that box 8 is resting on receptacle 6 which in this case is filled with water 80. Climbing ramp 2 is affixed to the top ledge of box 8. Guide panel 44 can be clearly seen as can be food tray 46. FIG. 5 shows a rodent 4 that has climbed ramp 2 and walked most of the length of plank 10. The rodent's head and body is forced between guide plate 44 and plank floor 10. Angled one way enforcement plates 60, 62 make it so that the rodent can't turn back to the entrance. The combination of the rodent's weight and the muscular movements of the rodent in its attempt to reach the bait 70 cause the magnetic attraction of magnet 26 to the ferrous metal portion of box floor 50 to break thereby causing pivot plank 10 to rotate as shown in FIG. 6, sending rodent 4 to a watery grave. When pivot plank 10 rotates down, a portion of it comes into contact with lid edge 76 thereby restricting the movement of plank 10 and insuring that it will rotate back to its start position as shown in FIG. 5. Of course, the owner of the present trap 100 can elect to leave the receptacle 6 empty and to remove the live rodent and release it in a remote location. Alternately, the receptacle 6 can be made air tight thereby asphyxiating the rodent. The user may also choose to use another liquid other than water. If the user wants to maintain the life of the rodent, he or she may elect to include food for the rodent in the bottom of the receptacle 6. FIG. 7 shows an alternate embodiment of the invention 100 where the invention 100 is attached to a lid 320 so that the lid can be affixed to a standard five gallon pail 310. Obviously, other diameter lid can be sized to fit on other standard trash cans. Additionally, the invention 100 can be scaled up or down to more efficiently catch larger or smaller rodents. For example, a smaller device can be designed specifically for mice and be small enough to be used in a home environment such as a kitchen or the like and not be obtrusive. In the above described and illustrated way, the present invention easily catches rodents of varying weights and sizes and deposits them in a receptacle. The trap then automatically resets itself and is ready to catch the next rodent without the need for human intervention.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. Rodent Trap comprising:
a lid;
a pivot plank;
a rectangular open topped box, containing four vertical sides, and a floor, said floor only occupying a portion of the rectangular area defined by said vertical sides, with the remainder of said rectangular area remaining open, thus forming an aperture in the bottom of said box:
said aperture and said floor being roughly of equal area;
a portion of said box be constructed of
ferrous metal material;
a magnet;
a pivot point;
a bait holding platform, affixed near one end of said rectangular box;
a guide panel;
a climbing ramp or rope;
a rodent catching receptacle, located below said rectangular box;
said guide panel and said bait holding platform fixed from side to side
across one end
of said rectangular box;
said pivot point holding said pivot plank located slightly more than half the length of said plank so that said plank can rotate about said pivot point;
said pivot plank including at least one magnet on its underside; said magnet or magnets capable of magnetically interacting with the ferrous metal
floor portion of said rectangular box;
so that a rodent can climb up said ramp or rope, travel along said pivot plank, wedge itself between said pivot plank and said guide panel in the pursuit of bait causing the magnetic attraction to break thereby causing said pivot plank to rotate downward and causing said rodent to drop through said aperture into said receptacle located below said rectangular box.

2. Rodent Trap as claimed in claim 1 further comprising one or more angled sharp one way enforcement panels positioned on the underside of said lid causing said rodent to move toward said guide panel but not back out of said trap.

3. Rodent Trap as claimed in claim 1 further comprising a carry handle located on the top of said lid and a removable pin that can retain said lid in the closed position when carrying said trap.

4. Rodent Trap as claimed in claim 1 wherein one end of said lid is hinaeably connected to a wall of said rectangular box via a standard metal hinge connection.

5. Rodent Trap as claimed in claim 1 wherein said pivot plank includes a plurality of receptacles on the underside of said plank for removably retaining an additional magnet at various forward or rearward locations in the forward half of the plank so that a magnet can be set toward the very forward end for heavier rodents such as rats or the magnet can be placed closer to the pivot point for lighter rodents such as mice.

6. Rodent Trap as claimed in claim 1 wherein said receptacle can remain empty until a rodent is deposited thereby leaving said rodent alive and well, or said receptacle can be partially filled with liquid so that said rodent will drown.

7. An alternate embodiment of said Rodent Trap as claimed in claim 1 wherein said trap is affixed to and surrounded by a lid; said lid capable of fitting securely on a five gallon container.

8. An alternate embodiment as claimed in claim 7 wherein said lid can be affixed to a standard trash can.
